(19) United States
(12) Patent Application Publication
(10) Pub. No.: US 2007/0033584 A1
(43) Pub. Date: Feb. 8, 2007

(54) Application update methods and mobile communication devices utilizing the same

(75) Inventor: Sz Lian Yu, Taipei City (TW)

Correspondence Address: QUINTERO LAW OFFICE, 1617 BROADWAY, 3RD FLOOR, SANTA MONICA, CA, 90404, US

(73) Assignee: LITE-ON TECHNOLOGY CORPORATION, TAIPEI (TW)

(21) Appl. No.: 11/305,788

(22) Filed: Dec. 16, 2005

(30) Foreign Application Priority Data
Aug. 3, 2005 (TW) TW94126337

(51) Int. Cl. G06F 9/44

(52) U.S. Cl. 717/168

(57) ABSTRACT

An application update method implemented in a mobile communication device. First, a menu of applications is displayed on the mobile communication device. A request for adding one new application listed on the menu to the mobile communication device is received. Component information indicating components blocks of the application is automatically determined. Communication devices each comprising at least one of the component blocks are also automatically determined. Different component blocks are simultaneously downloaded from different communication devices to the mobile communication device and assembled to form the application for execution.

### BACKGROUND

The invention relates to computer communication techniques, and in particular, to application update methods.

Conventionally, applications are burned on chips of an embedded system. To add any new application to an embedded system requires additional chip burning, thus, it is difficult.

Additionally, some embedded systems with writable/re-writable storage media must connect to a personal computer to import a new application, which is restrictive.

Republic of China patent publication NO. 00595197 discloses a user-customized application update method for cellular phones, wherein a cellular phone downloads selected applications from a web server utilizing an installed web browser.

Application download in this method proceeds under a client-server framework, such that a web server must serve a plurality of clients. When download requests exceeds, bandwidth is divided, and download speed suffers a threshold, and the web server may even crash due to heavy workload.

### SUMMARY

Accordingly, application update methods and mobile communication devices utilizing the same are provided.

An exemplary embodiment of an application update method is implemented in a mobile communication device. The mobile communication device displays a menu of applications and receives an update request to add an application shown by the menu to the mobile communication device. Component information indicating component blocks of the application is automatically determined. Other communication devices each comprising at least one of the component blocks are also automatically determined. The mobile communication device simultaneously downloads different component blocks from different communication devices through a wireless communication channel and automatically combines the component blocks to form the application for execution.

An exemplary embodiment of a mobile communication device comprises a display, an application manager, and a communication unit. The display shows a menu of applications. The application manager receives an update request to add an application shown by the menu to the mobile communication device, automatically determines component information indicating component blocks of the application, and automatically determines other communication devices each comprising at least one of the component blocks. The communication unit simultaneously downloads different component blocks from different communication devices to the mobile communication device through a wireless communication channel. The application manager automatically combines the component blocks to form the application for the mobile communication device to execute.

### DESCRIPTION OF THE DRAWINGS

The invention can be more fully understood by reading the subsequent detailed description and examples with references made to the accompanying drawings, wherein:

FIG. 1 is a block diagram of the configuration of a network and a mobile communication device;

FIG. 2 is a flowchart of an exemplary embodiment of an application update method;

FIG. 3 is a flowchart of distributed file exchange services; and

FIG. 4 is a flowchart of application uninstallation.

### DETAILED DESCRIPTION

Application update methods and mobile communication devices utilizing the same are provided. Note that entities, steps, and configurations thereof described in the following are only examples and can be adjusted according to real requirements.

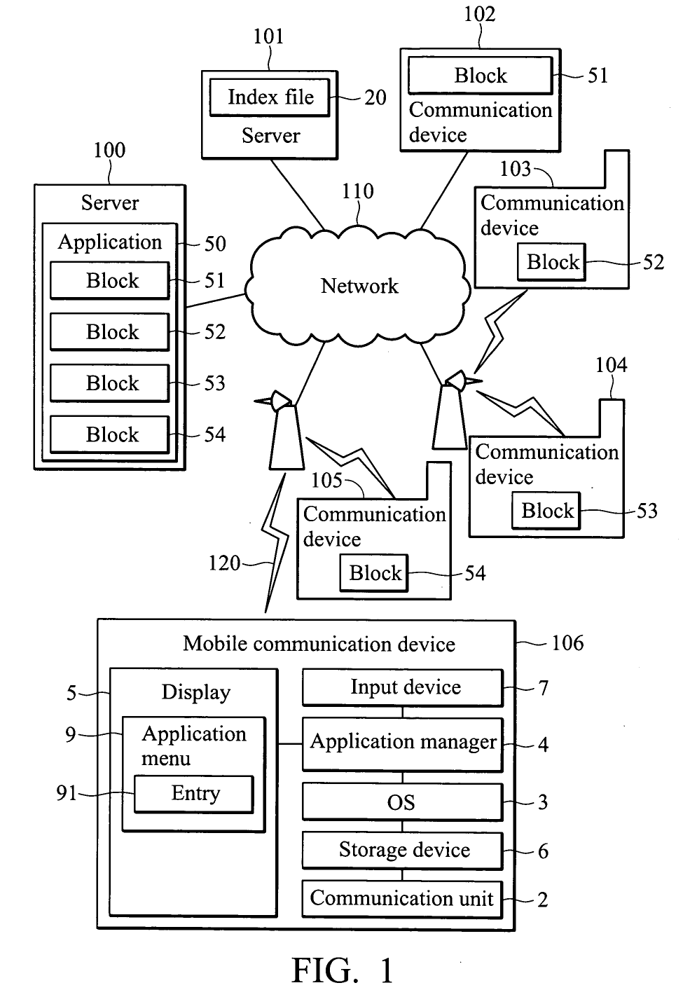

With reference to FIG. 1, network 110 is coupled to servers 100 and 101, communication device 102-105, mobile communication device 106. Communication device 102-105 may be personal computers, laptops, cellular phones, personal digital assistants (PDA), or others. Mobile communication device 106 may comprise an embedded system (such as a cellular phone or a PDA) with wireless communication capability. Servers 100, 101 and communication devices 102-105 may communicate with network 110 via wired or wireless connection. Mobile communication device 106 communicates with network 110 and other device through wireless communication channel 120.

Mobile communication device 106 comprises communication unit 2, operating system 3, and application manager 4, display 5, storage device 6, and input device 7. Application manager 4 may be implemented by circuits or a processor executing a computer program. Mobile communication device 106 may initially exclude no application, and, when initiating, implement an application update method.

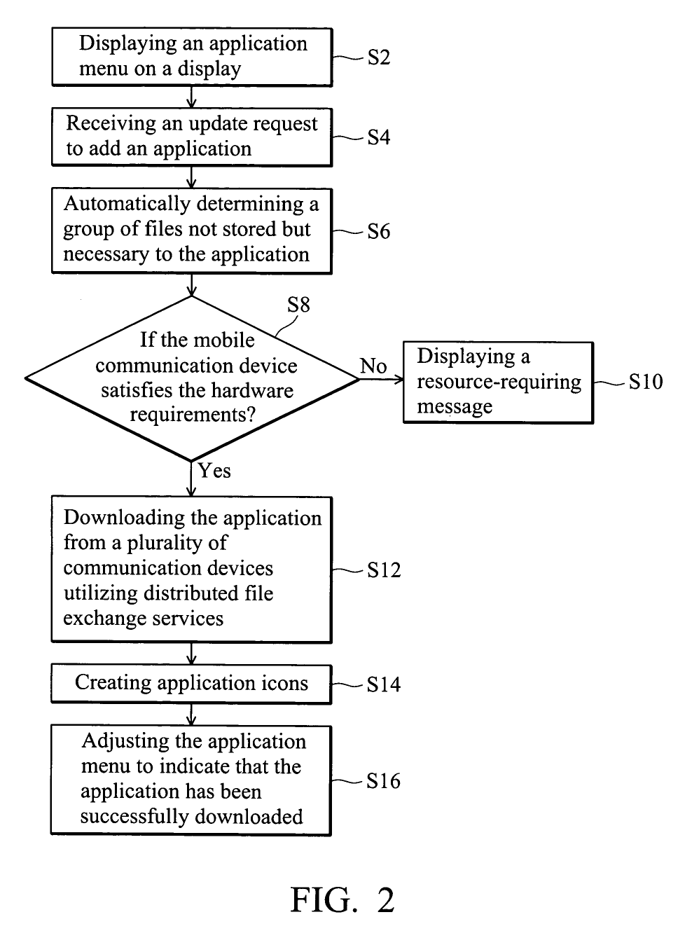

With reference to FIG. 2, when mobile communication device 106 is initiated, application manager 4 displays application menu 9 on display 5 (step S2). Menu 9 may be stored in mobile communication device 106 in advance. Application manager 4 receives an update request from input device 7 for adding an application shown by menu 9 to mobile communication device 106 (step S4). Mobile communication device 106 automatically performs the following steps in response to the request. For example, entry 91 in menu 9 corresponds to application 50 stored on server 100 shown in FIG. 1. Note that mobile communication device 106 does not actually download application 50 from server 100.

Application manager 4 requests OS 3 to perform steps S6 and S8.

In step S6, OS 3 automatically determines a group of files necessary to application 50 which are not stored on the mobile communication device 106, which may comprise executable files, configuration files, and ancillary data files. Files necessary to application 50 may partly have been stored on mobile communication device 106. Mobile communication device 106 only downloads the determined file group. Storage device 6 stores hardware requirement information of applications listed by menu 9.

In step S8, the OS determines if the mobile communication device satisfies the hardware requirement to install application 50. If not, OS displays a corresponding message on display 5 indicating that mobile communication device 106 does not have enough hardware resources and suggests adding new equipment (step S10).

If so, communication unit 2 downloads application 50 from a plurality of communication devices (such as communication devices 102-105) through wireless communication channel 120 utilizing distributed file exchange services (step S12). An exemplary tool for distributed file exchange services comprises BitTorrent.

When the download of application 50 is complete, application manager 4 installs application 50 and builds graphical user interface (GUI) icons thereof (step S14). Application manager 4 accordingly adjusts menu 9 to indicate that application 50 has been successfully downloaded (step S16).

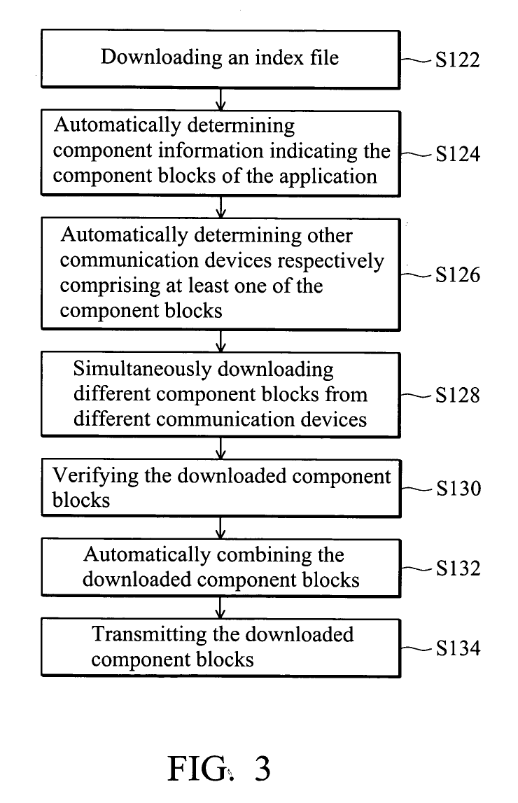

Step S12 is described in detail with reference to FIG. 3.

Communication unit 2 downloads index file 20 from server 101 through wireless communication channel 120 (step S122). Index file 20 may indicate component blocks of application 50 and communication devices respectively comprising at least one of the component blocks. Index file 20 may comprise other information. For example, index file 20 comprises file names and file sizes of the file group, checksum functions (such as hash functions) for verifying the component blocks, and addresses (such as Internet protocol (IP) addresses) of the distributed communication devices. The component blocks may be fragments of a file of application 50. Index file 20 and application 50 may be stored in a single server.

Application manager 4 automatically determines that the components of application 50 comprise component blocks 51-54 according to index file 20 (step S124). The component blocks 51-54 may form one or more file of application 50.

Application manager 4 automatically determines other communication devices (such as communication device 102-105) respectively comprising at least one of the component blocks (step S126). These communication devices may have downloaded or have been downloading application 50.

Communication unit 2 simultaneously downloads different component blocks from different communication devices to mobile communication device 106 through wireless communication channel 120 (step S128). For example, block 51 is downloaded from device 102; block 52 is downloaded from device 103; block 53 is downloaded from device 104; block 54 is downloaded from device 105.

Application manager 4 verifies if the downloaded component blocks comprise real components of application 50 indicated by the index file 20 (step S130) and automatically combines component blocks 51-54 to form application 50 for mobile communication device 106 to execute (step S132). When requested to upload component blocks of application 50, application manager 4 transmits portions of the downloaded component blocks through wireless communication channel 120 (step S134).

Application uninstallation is described in the following.

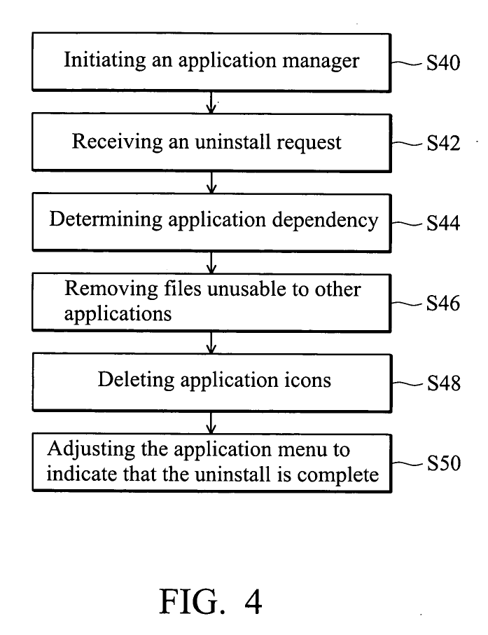

With reference to FIG. 4, application manager 4 initiates (step S40). When receiving a request for removing/uninstalling application 50 (step S42), mobile communication device 106 automatically performs the following steps.

OS 3 determines dependency between other applications and the group of files necessary to application 50 (step S44) and removes files unusable to other applications (step S46). Next, application manager 4 deletes icons of application 50 (step S48). Application manager 4 accordingly adjusts menu 9 to indicate that application 50 has been uninstalled (step S50).

Thus, a mobile communication device locally checks for hardware requirements and necessary application files, and simultaneously downloads application component blocks from a plurality of devices, and assembles them.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An application update method, implemented in a mobile communication device, comprising:
displaying a menu of applications on the mobile communication device;
receiving an update request for adding an application shown by the menu to the mobile communication device;
automatically determining component information indicating component blocks of the application;
automatically determining other communication devices, each comprising at least one of the component blocks;
simultaneously downloading different component blocks from different communication devices to the mobile communication device through a wireless communication channel; and
automatically combining the downloaded component blocks to form the application for the mobile communication device to execute.

2. The method as claimed in claim 1, wherein the menu is stored on the mobile communication device in advance.

3. The method as claimed in claim 2, further comprising:
storing hardware requirement information on the mobile communication device; and
determining if the mobile communication device satisfies the hardware requirement to install the application.

4. The method as claimed in claim 1, wherein the component blocks form a file of the application.

5. The method as claimed in claim 1, further comprising automatically determining a group of files necessary to the application and not stored on the mobile communication device, wherein the mobile communication device only downloads the group of files.

6. The method as claimed in claim 1, further comprising automatically verifying if the downloaded component blocks comprise real component blocks of the application indicated by the component information.

7. The method as claimed in claim 1, further comprising downloading an index file indicating the component blocks and the communication devices comprising at least one of the component blocks.

8. The method as claimed in claim 1, further comprising transmitting the downloaded component blocks through the wireless communication channel.

9. The method as claimed in claim 1, further comprising adjusting the menu to indicate that the application has been downloaded when the component blocks has been downloaded and combined to form the application.

10. A mobile communication device, comprising:
a display showing a menu of applications;
an application manager receiving an update request for adding an application shown by the menu to the mobile communication device, automatically determining component information indicating component blocks of the application, and automatically determining other communication devices, each of which comprises at least one of the component blocks; and
a communication unit simultaneously downloading different component blocks from different communication devices to the mobile communication device through a wireless communication channel, wherein the application manager automatically combines the downloaded component blocks to form the application for the mobile communication device to execute.

11. The device as claimed in claim 10, further comprising a storage device storing the menu in advance.

12. The device as claimed in claim 11, wherein the storage device stores hardware requirement information, and the application manager determines if the mobile communication device satisfies the hardware requirements for installing the application.

13. The device as claimed in claim 10, wherein the component blocks form a file of the application.

14. The device as claimed in claim 10, wherein the application manager automatically determines a group of files necessary to the application and not stored on the mobile communication device, and the mobile communication device downloads only the group of files.

15. The device as claimed in claim 10, wherein the application manager automatically verifies if the downloaded component blocks comprise real component blocks of the application indicated by the component information.

16. The device as claimed in claim 10, wherein the communication unit downloads an index file indicating the component blocks and the communication devices comprising at least one of the component blocks.

17. The device as claimed in claim 10, wherein the communication unit transmits the downloaded component blocks through the wireless communication channel.

18. The device as claimed in claim 10, wherein the application manager adjusts the menu to indicate that the application has been downloaded when the component blocks has been downloaded and combined to form the application.
